(19) United States
(12) Patent Application Publication
(10) Pub. No.: US 2018/0225249 A1
(43) Pub. Date: Aug. 9, 2018

(54) APPLICATION-SPECIFIC INTEGRATED CIRCUIT CONFIGURED TO INTERFACE WITH AUTOMOTIVE DIAGNOSTIC PORT

(71) Applicant: Automatic Labs, Inc., San Francisco, CA (US)

(72) Inventors: Nicholas Philip Lambourne, San Francisco, CA (US); David Theron Palmer, Fremont, CA (US)

(21) Appl. No.: 15/428,033

(22) Filed: Feb. 8, 2017

(51) Int. Cl. G06F 13/40; G07C 5/08; G06F 1/32

(52) U.S. Cl. CPC G06F 13/4072; G07C 5/08; G06F 1/3296; G06F 1/3293; G06F 13/4022

(57) ABSTRACT

A system and an application-specific integrated circuit are provided to interface with an automotive diagnostic port. The application-specific integrated circuit includes a plurality of automotive general purpose input/outputs and a digital toolbox. Each automotive general purpose input/output is coupled to a pad of an input/output port configured to be connected to a corresponding signal included in the automotive diagnostic port. The digital toolbox includes a number of modules configured to perform digital signal processing and a switch matrix coupled to the number of modules. The ASIC is specifically designed to be connected to a vehicle's electrical environment via an automotive diagnostic port connector included in many cars and light duty trucks sold worldwide as well as some commercial vehicles.

### FIELD OF THE INVENTION

The present invention relates to signal processing, and more particularly to an application-specific integrated circuit configured to interface with an automotive diagnostic port.

### BACKGROUND

Automotive diagnostic ports have been designed into a vehicle's electrical system since computers became common for running the engine and/or other electrical systems in vehicles. Examples of automotive diagnostic ports include General Motors' proprietary ALDL (Assembly Line Diagnostic Link), a California standard for OBD-I (On-Board Diagnostics), the Society of Automotive Engineers (SAE) J1962 specification for OBD-II for vehicles sold in the United States, the EOBD (European On-Board Diagnostics) for vehicles sold in the European Union, and the JOBD (Japanese On-Board Diagnostics) for vehicles sold in Japan. The automotive diagnostic ports enable a scan tool to be connected to the vehicle to retrieve diagnostic test codes (DTCs) from the electrical components in the vehicle coupled to the automotive diagnostic port. Other data, such as data relating to the emissions of the vehicle, may also be accessed via the automotive diagnostic ports.

Early-version automotive diagnostic ports were proprietary and each vehicle manufacturer designed dedicated scan tools to interface with that manufacturer's vehicle. Accordingly, manufacturers were free to connect each pin of the automotive diagnostic port connector to a variety of different voltages, signals, or communication buses. The variety of voltages and or signals that can be connected to a particular pin of the automotive diagnostic port makes it extremely difficult to design a single scan tool that is capable of interfacing with multiple vehicles from different manufacturers. Furthermore, even the newer standards such as OBD-II only specify the connections of a subset of pins on the automotive diagnostic port connector. The remaining pins are unspecified and can be utilized at the manufacturer's discretion.

Consequently, any tool designed to connect with the automotive diagnostic port of a wide range of vehicles could see a wide range of electrical interfaces (e.g., various voltages, termination, signaling protocols, and current flow) on any particular pin of the automotive diagnostic port connector. Typically, this drawback is handled by routing the signals on each pin of the automotive diagnostic port through analog circuits that are designed to condition the signals to make the signals safe to be coupled to a general input/output pad of an integrated circuit. For example, all of the signals may be switched through relays in order to change the voltage of the signals to a standard voltage. However, such analog circuits take up valuable real estate on printed circuit boards (PCBs) when the analog circuits are implemented outside of the digital signal processing (DSP) integrated circuit. These analog circuits also increase the cost to manufacture the scan tools or other components designed to interface with the automotive diagnostic port as the number of components that populate the PCB as well as the size and/or number of layers of the PCB is increased to accommodate these circuits. Other techniques for handling the electrical interfaces include designing a device to use a subset pins reserved for proprietary interfaces or leaving many pins with unknown interfaces disconnected from the device. Thus, there is a need for addressing this issue and/or other issues associated with the prior art.

### SUMMARY

A system and an application-specific integrated circuit are provided to interface with an automotive diagnostic port. The application-specific integrated circuit includes a plurality of automotive general purpose input/outputs and a digital toolbox. Each automotive general purpose input/output is coupled to a pad of an input/output port configured to be connected to a corresponding signal included in the automotive diagnostic port. The digital toolbox includes a number of modules configured to perform digital signal processing and a switch matrix coupled to the number of modules. The ASIC is specifically designed to be connected to a vehicle's electrical environment via an automotive diagnostic port connector included in many cars and light duty trucks sold worldwide as well as some commercial vehicles.

### BRIEF DESCRIPTION OF THE DRAWINGS

FIG. 1 illustrates an application-specific integrated circuit configured to interface with an automotive diagnostic port, in accordance with one embodiment;

FIG. 2 illustrates an automotive general purpose input/output, in accordance with one embodiment;

FIG. 3 illustrates the Input/Output Toolbox, in accordance with one embodiment;

FIG. 4 illustrates a package that includes the application-specific integrated circuit, in accordance with one embodiment;

FIG. 5A illustrates an OBD-II automotive diagnostic port connector, in accordance with the prior art;

FIG. 5B illustrates an early model BMW automotive diagnostic port connector 550, in accordance with the prior art;

FIG. 6 illustrates a system configured to be plugged in to an automotive diagnostic port, in accordance with one embodiment; and

FIG. 7 illustrates a schematic for connecting the application-specific integrated circuit to an automatic diagnostic port connector, in accordance with one embodiment.

### DETAILED DESCRIPTION

Automotive diagnostic ports provide an interface to a variety of electrical systems for a vehicle. Examples of automotive diagnostic ports include, but are not limited to, OBD-I, OBD-II, EOBD, and JOBD. The OBD-II physical interface is specified as a 16-pin, D-style connector. The OBD-II interface includes one pin connected to a battery voltage (pin 16 is connected to a 12V or 24V source voltage) and two pins connected to ground (pin 4 is connected to chassis ground of the vehicle and pin 5 is connected to a signal ground). The OBD-II interface also reserves six pins for three specific communications interfaces. Pins 2 and 10 are connected to a positive line and a negative line of an SAE J1850 serial communications bus, respectively; pins 6 and 14 are connected to a high signal and a low signal of a CAN (Controller Area Network) bus, respectively; and pins 7 and 15 are connected to a K-line and L-line of a Keyword Protocol 2000 serial communications bus, respectively. The OBD-II interface reserves the last seven pins (i.e., pins 1, 3, 8, 9, 11, 12, and 13) for proprietary use by each manufacturer. In other words, a vehicle manufacturer may utilize these seven pins to communicate with various electrical components in the vehicle to retrieve additional diagnostic information.

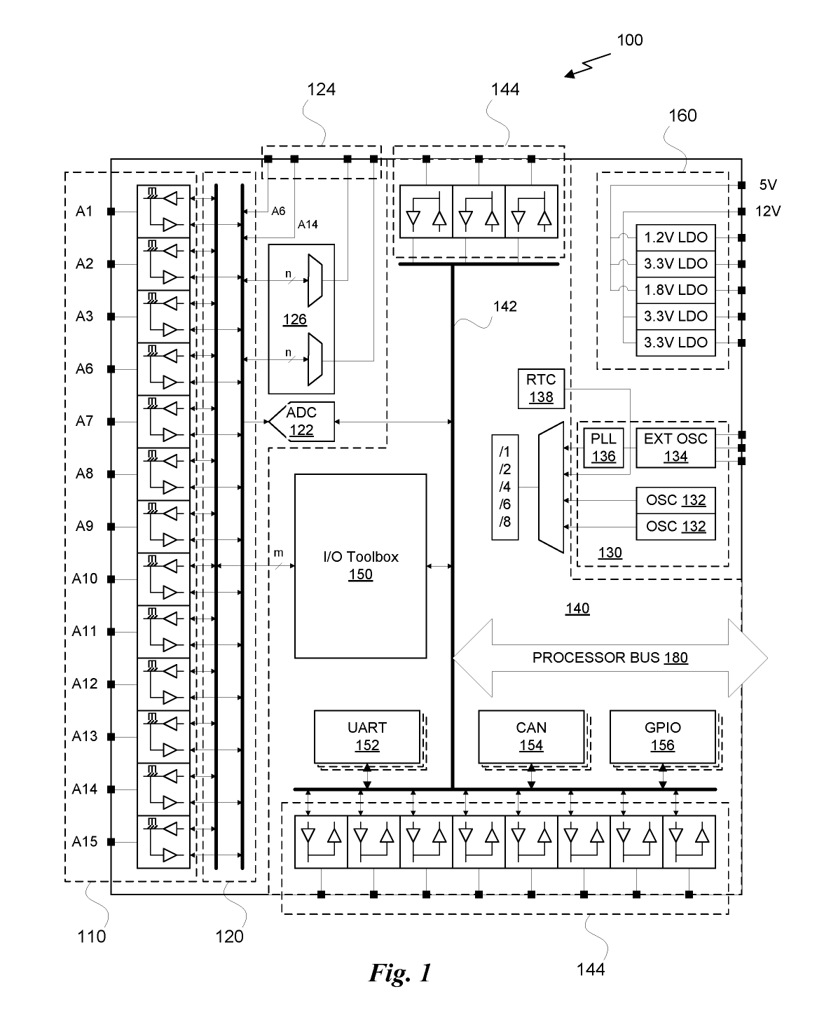

FIG. 1 illustrates an application-specific integrated circuit (ASIC) 100 configured to interface with an automotive diagnostic port, in accordance with one embodiment. The ASIC 100 is an integrated circuit formed in a silicon substrate. The ASIC 100 may include both an analog domain and a digital domain. The analog domain includes analog circuits comprising a number of components formed in the silicon substrate and configured to work with analog signals. The digital domain includes digital circuits comprising a number of components (e.g., CMOS logic) formed in the silicon substrate and configured to work with digital signals. Analog signals may be sampled by analog-to-digital converters (ADCs) to transition from the analog domain to the digital domain, and digital signals may be converted by digital-to-analog converters (DAC) to transition from the digital domain to the analog domain.

The ASIC 100 includes an input/output port 110 to interface with the automotive diagnostic port. The port 110 includes a number of pads, each pad designed to be coupled to a signal from one of the pins of the automotive diagnostic port. As shown in FIG. 1, in some embodiments, the port 110 includes 13 pads designed to be connected with the pins of an OBD-II diagnostic port, excluding the battery supply voltage and ground pins (i.e., pins 4, 5, and 16). Each pad is connected to an interconnect formed in the silicon substrate in order to route the signal at the pin to an I/O block designed to interface with a signal of an automotive diagnostic port, which may be referred to herein as automotive general purpose input/output (AGPIO).

It will be appreciated that 3 of the 16 pins of the OBD-II connector are reserved for the battery supply voltage and ground signals. The ASIC 100 may not need to interface with these pins directly, as the battery supply voltage and ground can be connected directly to a supply voltage for the ASIC 100. Therefore, in one embodiment, the ASIC 100 only includes 13 pads and 13 corresponding AGPIO in the I/O port 110. Of course, in various embodiments, the I/O port 110 may include a different number of pads and AGPIO in order to interface with one or more automotive diagnostic ports. For example, the I/O port 110 may include fewer pads and corresponding AGPIO to connect to only a subset of pins on the automotive diagnostic port. Alternatively, the I/O port 110 may include more pads and corresponding AGPIO to connect with a number of pins on a plurality of different automotive diagnostic ports. For example, the I/O port 110 may include a number of pads and corresponding AGPIO that matches the maximum number of pins in a plurality of different automotive diagnostic ports. Then, the same ASIC 100 can be utilized in a number of different applications, or with a number of different adapters to connect to more than one type of automotive diagnostic port.

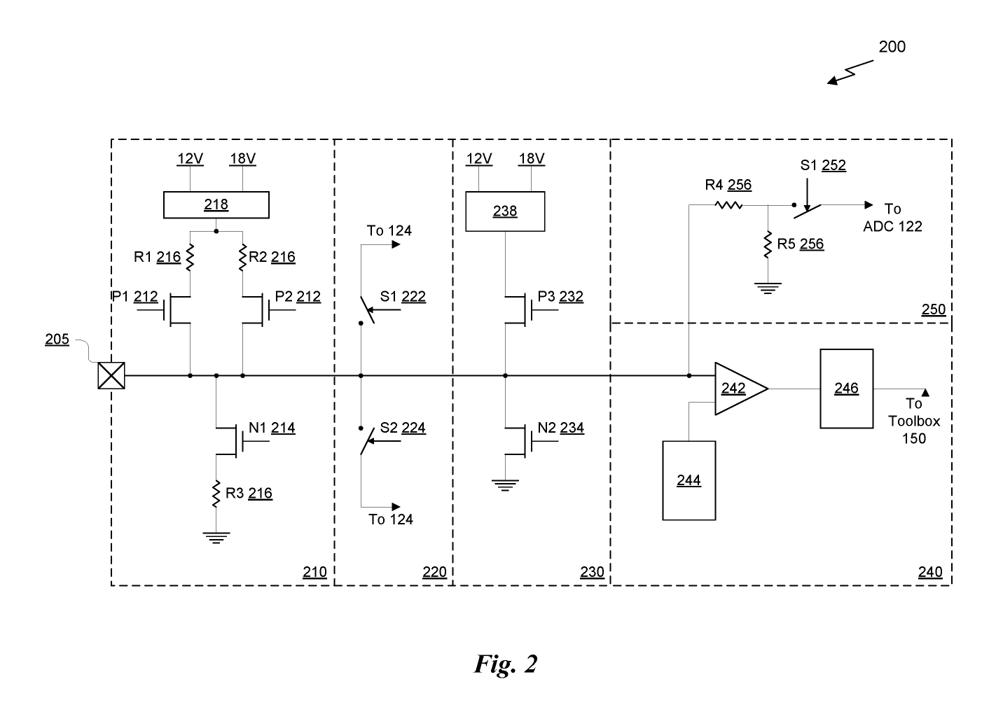

Each AGPIO is designed to operate when connected to a vehicle's electrical environment via the automotive diagnostic port connector. In one embodiment, the vehicle's electrical environment includes experiencing voltages applied to the input of the AGPIO ranging between −1 VDC and 40 VDC, operating in temperatures between −40° C. and 125° C., experiencing loss of ground protection, and normal operating voltages that may vary between different implementations of the automotive diagnostic port (e.g., 1.8 V, 3.3 V, 12 V, etc.). The vehicle's electrical environment is very different than a normal electrical environment of general purpose input/output (GPIO) implemented in conventional integrated circuits. For example, a normal GPIO may expect all signals connected to the GPIO pad to operate at a specific voltage (e.g., 3.3 V) and within a normal temperature range for processors in conventional packaging. Furthermore, the AGPIO may be expected to shunt large currents to a ground plane of the ASIC 100 without harming the integrated circuit that is out of the norm for conventional GPIO. The AGPIO will be described in more detail below in conjunction with FIG. 2.

Returning to FIG. 1, the AGPIO includes inputs and outputs coupled to a crossbar 120. In one embodiment, the crossbar 120 is configured with two ports: (1) a first port that can be configured to couple one or more outputs of the plurality of AGPIO to various components of the ASIC 100; and (2) a second port that can be configured to couple one or more components of the ASIC 100 to one or more inputs of the plurality of AGPIO. Each port may be reconfigured each clock cycle.

The crossbar 120 is connected to an ADC 122. The crossbar 120 may be configured to connect any of the signals from the I/O port 110 (e.g., A1-A3 and A6-A15) to an input of the ADC 122. In one embodiment, the ADC 122 is an 8-bit, 1 MHz, successive approximation data converter with an adjustable latency. Additional precision can be achieved by adjusting the full scale range of the ADC 122 to a subset of the default full scale range, set using a reference voltage generated with an internal bandgap of 0-3.3 VDC. The ADC 122 may be used to sample the analog signal received at a pad of the I/O port 110 and convert the signal to be processed in the digital domain 140 of the ASIC 100. The output of the ADC 122 may be coupled to a main system bus 142 in the digital domain 140 of the ASIC 100.

The ASIC 100 also includes an external CAN bus port 124 configured to connect pads of the I/O port 110 to a pair of external CAN bus transceivers. A first pair of pads in the external CAN bus port 124 may be connected to a first external CAN bus transceiver. In one embodiment, these pads are connected, via the crossbar 120, to the signals from pads A6 and A14 of the I/O port 110, which correspond with a high signal and a low signal of a CAN bus on the OBD-II automotive diagnostic port. A second pair of pads in the external CAN bus port 124 may be connected to an analog multiplexor 126. The analog multiplexor 126 enables a second external CAN bus transceiver to be coupled to any other pair of signals from the other pads of the I/O port 110 (e.g., pads A1-A3, A7-A13, and A15). One n-to-1 multiplexor in the analog multiplexor 126 connects a signal from a first pad of the I/O port 110 to the high signal (i.e., p line) for the second CAN bus transceiver, and another n-to-1 multiplexor in the analog multiplexor 126 connects a signal from a second pad of the I/O port 110 to the low signal (i.e., n line) for the second CAN bus transceiver.

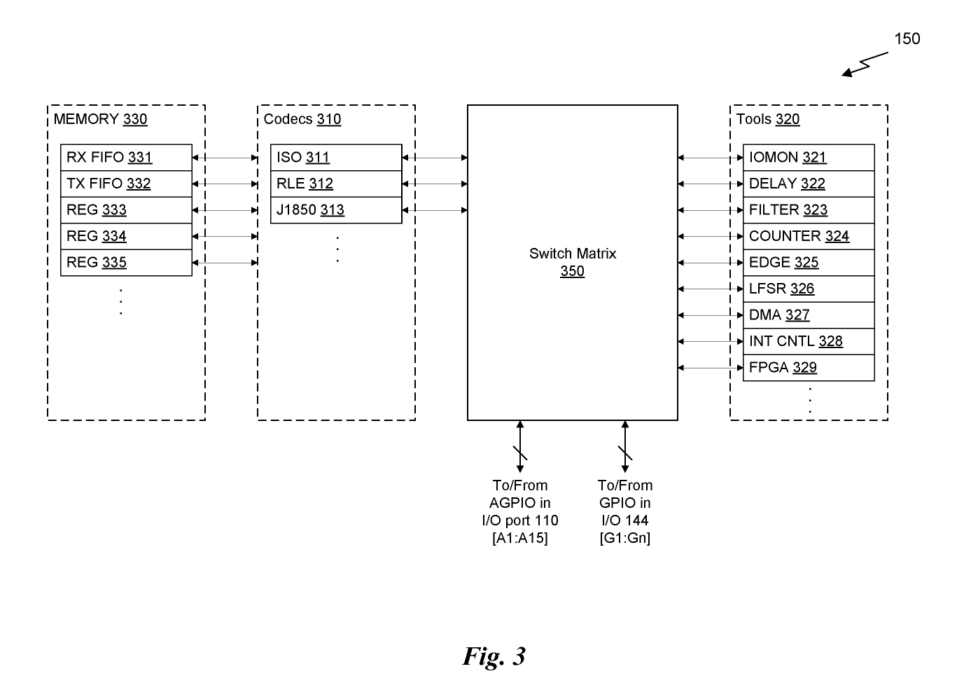

The crossbar 120 also connects m digital inputs from the I/O port 110 to the I/O Toolbox 150, which will be described in more detail below in conjunction with FIG. 3. The I/O Toolbox 150 is a collection of I/O protocol codecs for common automotive buses, a flexible set of modules for general purpose I/O, various signal processing tools such as filters, edge detectors, and delay modules, as well as buffers, registers, and a fully interconnected logical switching matrix to connect any source to one or more modules. Each module input can be connected to one source, and each module output can be connected to one or more destinations. The I/O Toolbox 150 enables the implementation of a flexible set of tools for performing general purpose I/O as well as signal processing without the real-time interaction of a CPU core.

The ASIC 100 includes a number of power generation components 160. In one embodiment, the ASIC 100 is coupled to a 12VDC source supplied from a vehicle's supply voltage (e.g., a battery voltage) as well as a 5VDC source supplied from an external voltage regulator. The ASIC 100 also includes a number of internal low-dropout voltage regulators (LDOs). The LDOs regulate either the 12VDC source from the vehicle or the 5VDC source from the external voltage regulator to supply various voltage domains with DC power at various levels. As shown in FIG. 1, the 5VDC source is coupled to a 1.2 VDC LDO, a 3.3 VDC LDO, and a 1.8 VDC LDO. The 12VDC source is coupled to a pair of 3.3 VDC LDOs. The LDOs may supply voltage domains to various components in the ASIC 100 as well as external components of the system coupled to one or more pads of the ASIC 100. It will be appreciated that, in other embodiments, other LDOs may be included in addition to or in lieu of the LDOs shown in FIG. 1. For example, additional 3.3 VDC LDOs may be included in the power generation components 160.

The ASIC 100 further includes a number of clock generation components 130. The clock generation components 130 include a number of RC oscillators 132 configured to generate a clock signal at various frequencies and an oscillator 134 that receives an oscillating signal from an external crystal oscillator and generates an external clock signal that matches the frequency of the external crystal oscillator. In one embodiment, a first RC oscillator 132 operates at 32.768 kHz, and a second RC oscillator 132 operates at 11 MHz, and the external crystal oscillator also must operate at 32.768 kHz. The external clock signal generated by the oscillator 134 is used to supply the input of a phase-locked loop (PLL) 136 that generates a system clock at 30 MHz. The external clock signal may also be output to supply a clock to the system connected to the ASIC 100. The clock signals from the clock generation components 130 are also tied to various components in the digital domain 140 of the ASIC 100.

In one embodiment, the external clock signal generated by oscillator 134 may be coupled to a real-time counter (RTC) 138. The 32.768 kHz signal increments a counter on each rising edge of the external clock signal. In one embodiment, the RTC 138 is a 44-bit counter. The value of the counter is a binary value representing an unsigned integer. The RTC 138 can be programmed to trigger an interrupt when the RTC 138 crosses a threshold value, as set in a special register. The RTC 138 may be reset when the interrupt is triggered in order to trigger interrupts at fixed intervals. The interrupts may be used to perform real-time operations. In one embodiment, the RTC 138 is only supplied by the external clock signal at a fixed frequency that matches the external crystal oscillator. The internal RC oscillator 132 at 32.768 kHz may not be accurate enough to ensure real-time operation due to process variations during fabrication and operating conditions such as fluctuating temperatures.

The clock signals from the RC oscillators 132, the external clock signal from the oscillator 134, and the system clock signal from the PLL 136 are tied to a multiplexor(s) that controls which clocks are enabled. In one embodiment, the external clock signal is routed to the RTC 138 via a multiplexor, which may enable or disable the RTC 138. The system clock may be selected from either the PLL 136 output at 30 MHz or the RC oscillator 132 output of 11 MHz. The output of the PLL 136 or the RC oscillator 132 is passed through a divider circuit that generates a system clock output of either 1×, ½×, ¼×, or ⅛× the frequency of the input to the divider circuit. Consequently, the system clock may be any of the following frequencies: 30 MHz, 15 MHz, 7.5 MHz, 3.75 Mhz, 11 Mhz, 5.5 MHz, 2.75 MHz, and 1.375 MHz. It will be appreciated that, in some embodiments, the frequencies of the oscillators and the available settings for the frequency of the system clock may be different than the frequencies described above.

The digital domain 140 of the ASIC 100 includes a number of I/O 144 coupled to the system bus 142 in order to provide digital I/O for the ASIC 100. The I/O 144 may include driving circuits to generate an output signal on each of the pads as well as level shifter logic to read an input signal on each of the pads. In one embodiment, all I/O 144 is configured to operate at 3.3 VDC logic levels, and can operate as tri-state outputs (i.e., logic high, logic low, and high impedence).

The digital domain 140 also includes a number of controllers for controlling the I/O 144. For example, the digital domain may include one or more UART (Universal Asynchronous Receiver/Transmitter) controllers 152, one or more CAN bus controllers 154, and one or more GPIO (General Purpose Input/Output) controllers 156. In one embodiment, the ASIC 100 includes four UART controllers 152, two CAN bus controllers 154, and one GPIO controller 156. Each UART controller 152 may be coupled to four pads included in I/O 144 tied to a transmit signal, a receive signal, an RTS (Request to Send) signal, and a CTS (Clear to Send) signal. Each CAN bus controller 154 may be coupled to three pads included in I/O 144 tied to a transmit signal, a receive signal, and a standby signal. Each GPIO controller 156 may be coupled to a number of pads included in I/O 144, the GPIO controller able to drive an output signal on each pad in the number of pads or read an input signal on each pad in the number of pads. For example, each GPIO controller may be able to control inputs and outputs for eight corresponding pads of the I/O 144.

Although not shown explicitly, the digital domain 140 may also include other controllers or components in addition to or in lieu of the controllers shown in FIG. 1. For example, the digital domain 140 may include a PWM (Pulse Width Modulation) controller for generating a PWM signal on one or more pads of the I/O 144. As another example, the digital domain 140 may include an I2C controller for communicating via the I2C communication protocol.

The ASIC 100 may also include a processor bus 180 configured to interface with a processor coupled to the ASIC 100. In one embodiment, the ASIC 100 is designed to be paired with an external CPU core on a second integrated circuit die that is flip-chipped with ASIC 100 to connect pads on one side of the ASIC 100 to pads on one side of the CPU core IC. The processor bus 180 enables fast communications between the digital domain 140 of the ASIC 100 and the CPU core coupled to the ASIC 100. Additional memory ICs (e.g., SDRAMs, Flash memory, etc.) may be connected to the CPU core IC to provide for volatile or non-volatile storage of data. The CPU core may be a RISC (Reduced Instruction Set Computer) processor such as an ARM® CPU core. In another embodiment, the digital domain 140 may include a CPU core that is coupled directed to the processor bus 180 within the integrated circuit of the ASIC 100. However, die size may be a limiting factor that precludes the CPU core from being included directly in ASIC 100.

FIG. 2 illustrates an automotive general purpose input/output 200, in accordance with one embodiment. An AGPIO 200 comprises a circuit implemented in a silicon substrate of the ASIC 100. The circuit is connected to a pad 205 of the I/O port 110, which is designed to be connected to a signal from one pin of the automotive diagnostic port. The circuit is divided into five sub-circuits: (1) a pull-up, pull-down (PUPD) sub-circuit 210; (2) a pass-thru CAN sub-circuit 220; (3) an output driver sub-circuit 230; (4) an input path sub-circuit 240; and (5) an ADC path sub-circuit 250. The signal from the pad 205 is routed to each of the five sub-circuits.

The PUPD sub-circuit 210 includes a pair of p-channel metal oxide semiconductor field effect transistors (MOSFETs) that implement pull-up functionality and a single n-channel MOSFET that implements pull-down functionality. A first p-channel MOSFET (pMOS) transistor (P1) 212 includes a drain connected to the signal from the pad 205, a source connected to a first resistor R1 216, and a gate connected to an enable signal to implement a strong pull-up functionality to a 12 VDC supply voltage. In one embodiment, the resistor R1 216 is a 510 Ohm polysilicon resistor which is connected, through a reverse current protection component 218 to a supply voltage of 12 VDC. A second pMOS transistor (P2) 212 includes a drain connected to the signal from the pad 205, a source connected to a second resistor R2 216, and a gate connected to an enable signal to implement a weak pull-up functionality to a 12 VDC supply voltage. In one embodiment, the resistor R2 216 is a 10 kOhm polysilicon resistor which is connected, through the reverse current protection component 218 to the supply voltage of 12 VDC. A first n-channel MOSFET (nMOS) transistor (N1) 214 includes a source connected to the signal from the pad 205, a drain connected to a third resistor R3 216, and a gate connected to an enable signal to implement a weak pull-down functionality to ground. In one embodiment, the resistor R3 216 is a 10 kOhm polysilicon resistor which is connected to ground.

In one embodiment, the reverse current protection component 218 may include a pair of pMOS transistors with a common node connected to the drain of both pMOS transistors and the 12 VDC supply voltage connected to the source of one pMOS transistor and the source of the other pMOS transistor coupled to the output of the reverse current protection component 218, which is then connected to the resistor R1 216 and the resistor R2 216. The gate of both pMOS transistors is then connected to a source of a third transistor, which may be, e.g., a bi-polar junction transistor, and a drain coupled to ground. When the third transistor is turned on, the pair of pMOS transistors are also turned on, enabling the 12 VDC current to flow through the reverse-biased channels of the pair of pMOS transistors. The gate of the third transistor may be tied to logic for detecting an overvoltage at the output of the reverse current protection component 218 (i.e., an overvoltage at the pad 205 caused by transient voltage spikes in the vehicles electrical system. In one embodiment, a comparator may compare the voltage at the output of the reverse current protection component 218 to a threshold voltage in order to determine when an overvoltage event has occurred and switch off the flow of current through the pair of pMOS transistors. The logic may utilize the 18 VDC supply as a threshold voltage that determines when to turn off the pair of pMOS transistor, or the threshold voltage may be set using a voltage divider to somewhere between the 12 VDC supply and the 18VDC supply. In another embodiment, the reverse current protection component 218 is implemented with TVS diodes instead of MOSFETs.

The PUPD sub-circuit 210 enables the signal at the pad 205 to be pulled up to the 12VDC supply voltage or pulled down to ground in order to prevent a floating input when the pad is connected to a high impedance external component. The strong pull-up function, weak pull-up function, and weak pull-down function can all be controlled individually by setting a bit in a special configuration register, which may be written by the CPU core in response to executing a series of instructions. It will be appreciated that the configuration of the PUPD sub-circuit 210 is exemplary, but that other pull-up or pull-down functionality may be implemented within the PUPD sub-circuit 210 by changing the resistance of each of the resistors, or adding more or removing each corresponding pair of MOSFET and resistor to match specific application requirements. For example, a strong pull-down functionality could be added to the PUPD sub-circuit 210 by including a second nMOS transistor coupled to a 510 Ohm resistor tied to ground.

The pass-thru CAN sub-circuit 210 includes analog switches that tie the signal at the pad 205 to the external CAN bus port 124. A first switch (S1) 222 connects the signal at the pad 205 to a high signal of the CAN bus port 124, and a second switch (S2) 224 connects the signal at the pad 205 to a low signal of the CAN bus port 124. In one embodiment, the switch 51 222 and the switch S2 224 are transistors, such as JFETs. A gate of the transistor is connected to an enable signal that turns on the transistor and passes the signal at the pad 205 to one of the four pads of the external CAN bus port 124, via the crossbar 120.

In one embodiment, the signal at pad 205 is connected to pads for the first external CAN bus transceiver if the pad 205 is tied to a particular pin of the automotive diagnostic port. For example, pads A6 and A14 of the I/O port 110, which are tied to pins A6 and A14 of the OBD-II port, are connected to a CAN bus of the vehicle and are routed to the first external CAN bus transceiver. The signal at pad 205 is connected to pads for the second external CAN bus transceiver, indirectly via the analog multiplexor 126, if the pad 205 is tied to any other pin of the automotive diagnostic port. In other words, the output of the pass-thru CAN sub-circuit 210 may be hardwired to one of the pair of pads in the external CAN bus port 124, where two of the pads of the I/O port 110 are hardwired to a first pair of pads in the external CAN bus port 124, and eleven of the pads of the I/O port 110 are hardwired to a second pair of pads in the external CAN bus port 124.

The output driver sub-circuit 230 enables the ASIC 100 to output a digital signal on the pad 205 using a configurable logic level. In one embodiment, the output driver sub-circuit 230 includes an nMOS transistor (N2) 234 that can be enabled to implement a strong drive logic low functionality. The output driver sub-circuit 230 may also include a pMOS transistor (P3) 232 that can be enabled to implement a strong drive logic high functionality. The transistor P3 232 may be coupled to a LDO voltage regulator 238 with reverse current protection. The LDO voltage regulator 238 is supplied with a 12 VDC supply voltage, which is used to generate one or more output voltages at one or more logic levels. In one embodiment, the LDO voltage regulator 238 is designed to generate a 5 VDC supply and an 8 VDC supply. The particular voltage level generated by the LDO voltage regulator 238 may be selected with a control signal and turned on in response to an enable signal. The reverse current protection in the LDO voltage regulator 238 may be implemented similar to the reverse current protection component 218, except coupled to the output of the LDO voltage regulator 238 instead of being coupled directly to the 12 VDC supply voltage. Furthermore, the 18 VDC supply may be used to generate the threshold voltage for triggering an overvoltage condition that restricts current flow.

In one embodiment, the transistor P3 and the LDO voltage regulator 238 may be omitted from the AGPIO 200 connected to some pads of the I/O port 110. Consequently, the AGPIO 200 connected to some pads of the I/O port 110 may include the functionality to drive the output strong high (e.g., 5V/8V/etc.) and strong low (e.g., ground), while the AGPIO 200 connected to other pads of the I/O port 110 may only include the functionality to drive the output strong low, relying on the pull-up functionality of the PUPD sub-circuit 210.

The input path sub-circuit 240 enables the ASIC 100 to output a digital signal on the pad 205 using a configurable logic level. In one embodiment, input path sub-circuit 240 includes a comparator 242, a threshold select unit 244, and level shifter logic 246. The threshold select unit 244 enables various logic levels to be utilized as a digital input at the pad 205. In one embodiment, the threshold select unit 244 includes the ability to select from three different logic levels: (1) 5 VDC, (2) 8VDC, and (3) 12 VDC. The threshold select unit 244 generates a threshold voltage at approximately half of the full range voltage for a particular logic level. For example, the threshold select unit 244 generates a threshold voltage of approximately 6 VDC for a 12 VDC logic level (i.e., 12 VDC for logic high and 0 VDC for logic low), approximately 4 VDC for an 8 VDC logic level, and approximately 2.5 VDC for a 5 VDC logic level. The output of the threshold select unit 244 is connected to one input of the comparator 242, and the other input of the comparator is connected to the signal at the pad 205.

The comparator 242 generates an output at one of the rails of the supply of the comparator (e.g., 12 VDC). If the signal at the pad 205 is less than the threshold voltage generated by the threshold select unit 244, then the output of the comparator 242 is driven to the negative supply rail (e.g., 0 VDC). If the signal at the pad 205 is more than the threshold voltage generated by the threshold select unit 244, then the output of the comparator 242 is driven to the positive supply rail (e.g., 12 VDC). The output of the comparator 242 is connected to level shifter logic 246 to convert the logic level at the output of the comparator to a logic level compatible with the digital domain 140 (e.g., 3.3 VDC). The output of the level shifter logic 246 is connected to the I/O toolbox 150.

The ADC path sub-circuit 250 the ASIC 100 to measure an analog signal on the pad 205 using the ADC 122. The ADC path sub-circuit 250 connects the signal at the pad 205 to the ADC 122, via the crossbar 120, and is enabled by a switch (S3) 252. In one embodiment, the switch S3 252 is a transistor, such as a JFET, and a gate of the transistor is connected to an enable signal that turns on the transistor and passes the signal at the pad 205 to the ADC 122. The current flow to the ADC 122 is limited by a resistor R4 256, which may have a high resistance such as 1.4 MOhms. The amplitude of the signal provided to the ADC 122 is also not exactly the same as the amplitude of the signal at the pad 205, because the signal at the pad 205 is connected through a high impedance path to ground, via resistor R4 256 and resistor R5 256. The two resistors in series act as a voltage divider such that the amplitude of the signal transmitted to the ADC 122 is less than the amplitude of the signal at the pad 205. The gain of the voltage divider is set based on the ratio of resistance of the two resistors R4 256 and R5 256. In one embodiment, R5 256 has a resistance of 320 kOhms. The reason for reducing the amplitude of the signal transmitted to the ADC 122 is to reduce a full scale range of the ADC 122 to be less than the full scale range of the signal at the pad 205. Using a voltage divider in this fashion increases the signal to noise ratio (SNR) of the analog signal to get the benefit of a reduced complexity of the ADC 122.

FIG. 3 illustrates the I/O Toolbox 150, in accordance with one embodiment. As shown in FIG. 3, the I/O Toolbox 150 includes a number of I/O protocol codecs 310 for common automotive communications buses, a flexible set of tools 320, on-chip memory 330 including buffers and registers, and a fully interconnected logical switching matrix 350. The switching matrix 350 is configurable to connect various inputs to one or more codecs 310 and/or modules 320. In one embodiment, the inputs connected to the switching matrix 350 include the binary signal from the input path sub-circuit 240 of each AGPIO 200 coupled to a pad 205 of the I/O port 110. The I/O Toolbox 150 may include a digital front end that converts the binary signals from the input path sub-circuits 240 of each AGPIO 200 routed to the I/O Toolbox 150 to a digital signal sampled according to the system clock. The inputs connected to the switching matrix 350 may also include the digital signal of one or more GPIO coupled to a pad of the I/O 144.

In one embodiment, the I/O Toolbox 150 implements power-saving features. Each module (i.e., codecs 310, tools 320, and/or memory 330) may be subject to a hard reset condition that clears any state within the module and returns the module to a default state. In addition, each module may include circuitry for implementing clock gating. Clock gating prevents the system clock from being distributed to at least a portion of the module in order to prevent activity in the transistors of the module, which saves energy when the module is not in use.

The switch matrix 350 enables each of the modules in the I/O toolbox 150 to be interconnected. The term interconnected, within the context of the switch matrix 350 refers to the ability of the switch matrix 350 to be configured to couple an input node of a particular module (destination) to any source. As used herein, a source may be any one of the signals from the AGPIO included in I/O port 110 or the GPIO signals in I/O 144, as well as the output of any module. In one embodiment, each module includes a destination register that can be set to a value that indicates where the output of that module (source) should be routed in the switch matrix. The destination register can be written by software, executed in the CPU core, or by DMA request via a DMA controller in the digital domain 140.

In one embodiment, the input node of each module may only be connected to one source, but each module may specify zero or more destinations for the output. In another embodiment, the input node of each module may only be connected to one source and the destination register for the module may only specify zero or one destinations. In yet another embodiment, each module may include two or more input nodes, which may each be coupled to a different source. In one embodiment, the input node for a module may include a selectable inverter to invert the polarity of the source at the input node.

In one embodiment, the immediate state of each source signal coupled to the switch matrix 350 can be read by software by accessing special registers. In other words, the output of each module as well as the signals from the AGPIO and GPIO are stored in the registers, and updated by the modules coupled to the switch register (or updated as the signals on the pads of the AGPIO/GPIO are toggled externally. In another embodiment, a number of n-bit registers are used to store the previous n values of each source signal, with one register being associated with each source signal. The registers act as shift registers that store the state of the source signal for the previous n clock cycles.

The codecs 310 include blocks of digital logic to implement one or more I/O protocols. As shown in FIG. 3, the codecs 310 include, but are not limited to, an ISO controller 311, a run length encoder (RLE) controller 312, and a J1850 controller 313. It will be appreciated that other types of controllers may be implemented within the modules of codecs 310 to implement other communications protocols.

The ISO controller 311 is suitable for receiving or transmitting data encoded according to the ISO9141-2 or ISO14230 protocols. Under both protocols, the interpretation of data is dependent on the idle time of the communications bus immediately preceding each received symbol. The ISO controller 311 measures the idle time between symbols and stores a flag to indicate which symbols are the start of a frame or to indicate which symbols are the continuation of a frame. The timing of the inter-frame period and baud rate utilized by the ISO controller 311 are configurable in software, as executed by a CPU core. The baud rate is based on the system clock.

In one embodiment, the ISO controller 311 implements both a receiver and a transmitter. The ISO receiver module receives data symbols and stores data symbols in a RX FIFO 331 in the on-chip memory 330. The RX FIFO 331 can be accessed by software executed in the CPU core or by direct memory access (DMA) requests processed by a DMA controller in the digital domain 140. The ISO transmitter module transmits data symbols stored in a TX FIFO 332. In one embodiment, each byte stored in the TX FIFO 332 includes a flag in the most significant bit (MSB) that indicates whether the byte is the start of a frame of data. The ISO transmitter module, upon detecting the bit in a particular byte of the TX FIFO 332, will monitor the communications channel specified as the destination of the ISO controller 311 to wait for a bus idle condition. Once the bus has been idle longer than a programmable duration, the ISO controller 311 will transmit the data for the frame over the communications channel. It will be appreciated that although the ISO controller 311 is described as implementing both a transmitter and receiver in the same module of the codecs 310, separate and distinct modules for both the receiver and transmitter may be implemented within the codecs 310.

The RLE controller 312 enables the encoding or decoding of two RLE waveforms with a high-degree of timing precision, without any assistance from the CPU core. In one embodiment, the RLE controller 312 implements both a receiver and a transmitter. The RLE receiver module records a timestamp for each rising or falling edge of up to two waveforms. Each time at least one waveform has either a rising or falling edge, a timestamp is stored in a RX FIFO 331. The relative distance between successive timestamps indicates the number of bits at a particular state in the digital signal. The RLE transmitter module may generate up to two waveforms based on a particular state set in a first register and a number of clock cycles for encoding that state set in a second register. The value in the first register will be toggled when the number of clock cycles in the second register has expired, and the value in the second register will be updated based on a value popped from the TX FIFO 332. If the TX FIFO 332 is empty when the number of clock cycles in the second register has expired, then the output is set to zero.

The J1850 controller 313 can send and receive J1850 frames utilizing Variable Pulse Width (VPW) and Pulse Width Modulation (PWM), in both differential and fault-tolerant, formats. In one embodiment, the J1850 controller is configured with timing parameters that can be individually controlled by software, executed in the CPU core. A register may be set to switch between the different modes of operation (i.e., VPW, PWMd, PWMft, etc.). The J1850 controller 313 utilizes a data register and a length register to load data for transmission on the communications channel. A start register may be used to start transmission of a frame of data. Each frame of data may be re-transmitted upon detection of an error or a loss of arbitration on the communications channel.

It will be appreciated that although only three exemplary modules are shown as being included in the codecs 310, in some embodiments, additional modules may be implemented within codecs 310 to control additional communications channels according to different protocols. In addition, multiple instances of the same modules may be included in the codecs 310 to control multiple communications channels in parallel.

The memory 330 includes on-chip memory that can be addressed by software executing in the CPU core (e.g., via DMA requests initiated on the processor bus 180 by the CPU core) and is accessible by the controllers of the various modules included in the codecs 310. As shown in FIG. 3, the memory 330 may include buffers such as RX FIFO 331 and TX FIFO 332 as well as a register file that includes a plurality of registers such as registers 333, 334, and 345. It will be appreciated that, in some embodiments, the memory 330 may include a different number of buffers or registers than shown in FIG. 3. For example, receive and transfer FIFOs for each module may be included in the memory rather than sharing FIFOs between multiple modules, or the number of registers may be changed in order to accommodate the requirements of different modules.

In addition to the codecs 310, the I/O Toolbox 150 also includes additional tools 320. The tools 320 include other modules that are not specifically related to encoding or decoding signals according to a specific communications protocol. In one embodiment, the tools 320 include an I/O Monitor module 321, a delay module 322, a filter module 323, a counter module 324, an edge detection module 325, a linear-feedback shift register (LFSR) module 326, a DMA module 327, an interrupt control module 328, and an FPGA (Field Programmable Gate Array) module 329.

The I/O Monitor module 321 is configured to monitor a signal to detect errors on a communications bus. The output of the I/O Monitor module 321 indicates whether an error has been detected. The I/O Monitor module 321 may also be configured to trigger an interrupt and/or disable AGPIO output in response to detecting an error on the communications bus.

The delay module 322 implements a digital delay line that propagates the input to the output after a programmable number of clock cycles.

The filter module 323 implements a filter on the signal. In one embodiment, the filter is an integrating filter that removes glitches (e.g., short pulses) on the input signal. The threshold for the length of a pulse that is filtered out may be configured by software executed in the CPU core.

The counter module 324 implements an event counter and may be configured to trigger an interrupt when the counter value passes a threshold. Examples of events include, but are not limited to, removing a glitch by the filter module 323, receiving a frame on a communications bus, detecting a rising or falling edge of a signal, detecting an error or loss of arbitration on a communication bus, and the like.

The edge detection module 325 can be configured to detect either a rising edge, a falling edge, or both a rising and falling edge in the input signal. Detection of an edge may trigger an interrupt, increment a counter, trigger a DMA request, or trigger data to be transmitted over a communications channel.

The LFSR module 326 implements a 16-bit LFSR that can be used to generate noise or may be used as a 1-bit random number generator. A probability of the output being a 1 or 0 can be controlled by software, and may have a number of pre-programmed settings. For example, the output signal may be programmed to have a ratio of logic 1 to logic 0 of 50%, 25%, 12.5%, 6.25%, 3.13%, 1.56%, and 0.78%. In other embodiments, the probability may be set using a register (e.g., an 8-bit value may specify a ratio of n/256, where n is the 8-bit value).

The DMA module 327 may be used to configure the behavior of four DMA channels utilized by the I/O Toolbox 150, and can be used to read or write to any of the buffers or registers in the memory 330.

The interrupt control module 328 controls interrupts. A number of different events can trigger interrupts within the I/O Toolbox 150 (e.g., edge detection, communications bus errors, a counter exceeding a threshold value, etc.) The interrupt control module 328 may be used to manage the interrupts, such as by capturing or masking each of the different types of events. The interrupt control module 328 may cause an interrupt request to be transmitted to the CPU core via the processor bus 180 in response to capturing an event, unless that event is masked.

The FPGA module 329 may be used to implement arbitrary digital logic. In one embodiment, the FPGA module 329 includes 16 configurable logic blocks, each containing one 4-input LUT and one flip-flop. The FPGA module 329 may also include, a number of counters, input buffers, output buffers, a routing matrix for connecting the configurable logic blocks, and a global clock network.

It will be appreciated that, in some embodiments, the number and type of modules included in the tools 320 may be different than the tools 320 described above. The tools 320 may include multiple instances of the same module, or may include other modules in addition to or in lieu of the modules shown in FIG. 3. For example, the tools 320 may include dummy modules that always output a 0 or a 1 in order to set the output state of the output driver sub-circuit of an AGPIO. Furthermore, although not shown explicitly, the tools 320 may be coupled to the memory 330 such that the modules in the tools 320 can access buffers or registers in the memory 330.

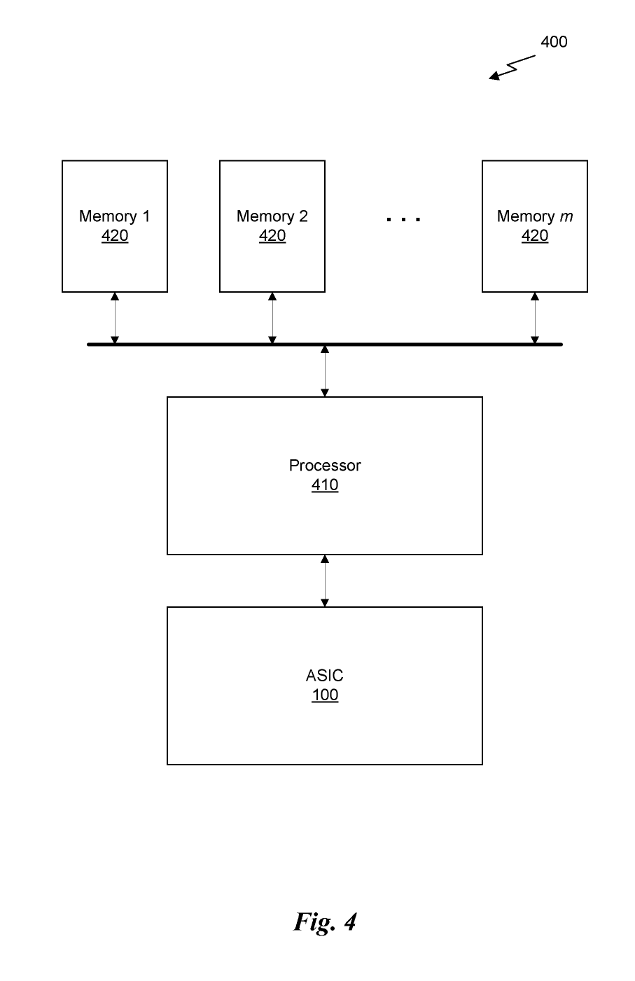

FIG. 4 illustrates a system 400 that includes the ASIC 100, in accordance with one embodiment. In one embodiment, the system 400 is contained in a package that includes one or more integrated circuit dies encapsulated in a resin or other material. The system 400 may include connections between the integrated circuit dies, such as with vias and printed circuits in a polymer substrate on which the dies are mounted or via metal paths such as solder bumps placed between pads on the dies in flip-chip technology or wires that have been bonded between pads on the dies in wire-bonding technology. The one or more dies are typically molded inside a resin material that completely encapsulates the one or more dies. Prior to molding, electrical connections may be made between at least some of the pads on at least one die and external leads such as pins or a ball grid array formed on a laminate substrate. In one embodiment, the system 400 is implemented as a QFN (Quad Flat No-leads) package with 72 external pins. In other embodiments, other packaging types may be utilized to stack the one or more dies. In yet other embodiments, package-on-package (PoP) technology may be employed to connect multiple packages containing subsets of the one or more dies in a single component.

As shown in FIG. 4, the system 400 includes the ASIC 100, a processor 410, and one or more memory modules 420. In one embodiment, the processor 410 may be a system-on-chip (SoC) that includes one or more CPU cores, one or more GPU cores, a memory management unit (MMU), a radio transceiver, a network interface controller (NIC), and the like. In another embodiment, the processor 410 may simply be a single CPU core. The single CPU core may be implemented on the same integrated circuit die as ASIC 100 or on a different integrated circuit die connected to ASIC 100.

In one embodiment, the processor 410 is a RISC-type microprocessor such as an ARM® Cortex CPU. The processor bus 180 of the ASIC 100 may be connected to a plurality of pads on the ASIC 100 that are coupled to a corresponding plurality of pads on integrated circuit die of the processor 410. Consequently, the CPU core in the processor 410 may be able to communicate with the digital domain 140 of the ASIC 100. The CPU core of the processor 410 can then transmit DMA requests on the processor bus 180 in order to read or write data from on-chip memory in the ASIC 100.

The processor 410 may also include a memory interface coupled to a memory controller. In one embodiment, the memory 420 includes one or more SDRAM (Synchronous Dynamic Random Access Memory) modules coupled to a memory interface of the processor 410. The memory controller of the processor 410 is then configured to transmit read or write requests to the SDRAM modules to store volatile data. In another embodiment, the memory 420 includes one or more flash memory modules such as a NAND flash memory module. In yet another embodiment, the memory 420 is omitted from the system 400 and the processor 410 is coupled to the memory via an external memory interface.

In another embodiment, the ASIC 100, the processor 410, and the one or more memory modules 420 are implemented as separate packages. In such an embodiment, the system 400 may include a printed circuit board on which each of the separate packages is mounted and a plurality of traces to route signals between the various devices.

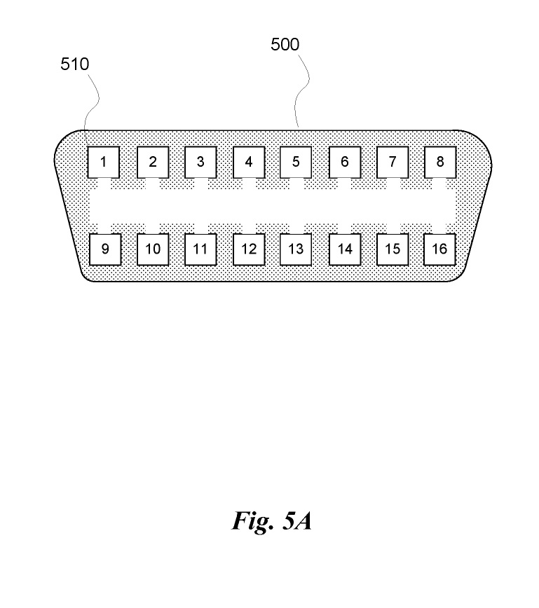

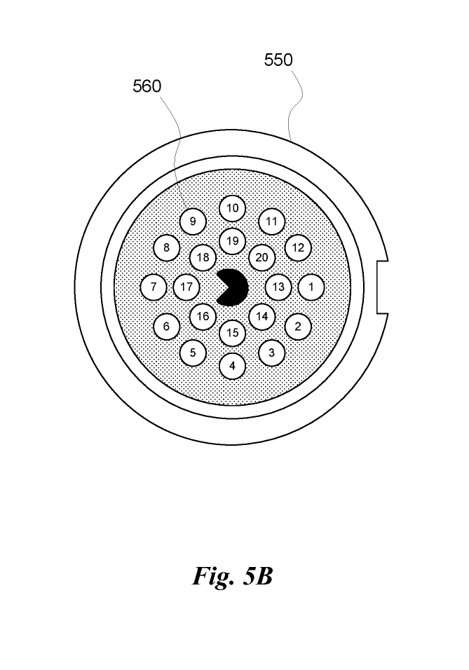

FIG. 5A illustrates an OBD-II automotive diagnostic port connector 500, in accordance with the prior art. The connector 500 for the OBD-II automotive diagnostic port was standardized as the SAE J1962 specification, which was issued in 1992. The United States has mandated inclusion of the OBD-II automotive diagnostic port connector 500 in any cars and light duty trucks sold in the U.S. market. The connector 500 is found within a specified distance of the steering column on all new cars/light duty trucks.

As shown in FIG. 5A, the OBD-II automotive diagnostic port connector 500, on a female connector, includes 16 sockets 510 arranged in two rows. A top row includes sockets 1 through 8, and a bottom row includes sockets 9-16. The sockets 510 accept 16 corresponding pins on a mating male connector. Sockets 2 and 10 are connected to a J1850 communications channel, sockets 6 and 14 are connected to a CAN communications channel, and sockets 7 and 15 are connected to an ISO 9141-2/14230-4 communications channel. Socket 4 is connected to a chassis ground of the vehicle, socket 5 is connected to a signal ground for the electrical system, and socket 16 is connected to a battery supply voltage of the vehicle. The remaining sockets 510 of the connector 500 are reserved to the manufacturers' to implement additional diagnostic communications channels.

FIG. 5B illustrates an early model BMW automotive diagnostic port connector 550, in accordance with the prior art. Prior to various regulatory agencies mandating the use of a particular automotive diagnostic port connector, such as the OBD-II connector, in order to sell vehicles in a particular market, many manufacturers utilized a proprietary connector to interface with the diagnostic information provided by the vehicle. One such connector was the connector 550 shown in FIG. 5B. The female connector 550 included 20 sockets 560 configured to interface with 20 pins of a mating male connector. Socket 19 is connected to chassis ground, socket 14 is connected to a battery supply voltage of the vehicle, and the remaining sockets are connected to proprietary interfaces. For example, sockets 15 and 20 are connected to a receive data link and transmit data link to all control units, respectively. Socket 7 is connected to a service light reset, and socket 1 is connected to an engine speed signal.

Other manufacturers, at one time or another, have used various connectors in addition to the connectors shown in FIGS. 5A and 5B. For example, some Porsche vehicles utilized a 19-pin connector and some Mercedes Benz vehicles utilized a 14-pin connector. It will be appreciated that the ASIC 100 may include any number of AGPIO 200 within the I/O port 110 such that the ASIC 100 can communicate with any of these connectors utilizing a simple adapter to connect any socket of the vehicle's automotive diagnostic port connector to any one of the pads 205 of the I/O port 110.

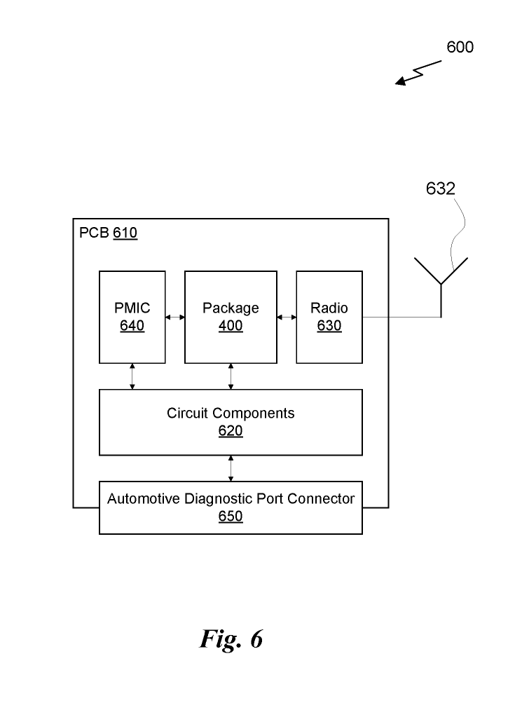

FIG. 6 illustrates a system 600 configured to be plugged in to an automotive diagnostic port, in accordance with one embodiment. The system 600 includes a printed circuit board (PCB) 610, on which a variety of electrical components have been mounted. In one embodiment, the PCB 610 is a multi-layer laminate with printed/etched metallic traces included therein on one or more layer to form various circuits and connect the electrical components.

As shown in FIG. 6, the system 600 includes the package 400, including ASIC 100, mounted thereon via a surface mount technique. The package 400 may be soldered to the board to connect the ASIC 100 to an automotive diagnostic port connector 650. In one embodiment, the automatic diagnostic port connector 650 is a male connector that includes a plurality of pins that fit into corresponding sockets of a mating, female diagnostic port connector included on a vehicle and connected to the vehicle's electrical system. The connector 650 may be D-type OBD-II connector, where the pins of the connector are soldered to a plurality of traces on the PCB 610.

The system 600 includes a power management integrated circuit (PMIC) 640 and a radio 630 coupled to the package 400. The radio 630 enables wireless communications through radio frequency (RF) channels. A wireless signal is transmitted to a receiver on another device via the antenna 632. In one embodiment, the radio 630 is used to implement Bluetooth® communication with another device, such as a cellular phone, a laptop, or another consumer device. In one embodiment, the Bluetooth communications channel can be used to communicate with the vehicle's audio system, in order to relay audio messages to a user.

The PMIC 640 is utilized to manage the power supplied to the package 400. In one embodiment, the system 600 receives power from the vehicle via the connector 650. For example, the connector 650 may couple pin 4 of an OBD-II connector to a ground plane of the PCB 610 and connect pin 16 to the PMIC 640, which includes a voltage regulator to generate a supply voltage (e.g., 12 VDC) for the package 400. The PMIC 640 may also include logic for placing the system 600 in a power saving mode. The power-saving mode may involve power-gating the package 400, thereby placing the ASIC 100 into a hard reset when the power is cycled. The ASIC 100 and/or the processor 410 may monitor various systems or signals to detect when to place the package 400 into a power saving mode. In one embodiment, the ASIC 100 and/or processor 410 may detect that the system 600 is idle, and place the ASIC 100 and/or processor 410 into a standby mode. The standby mode may include reducing a supply voltage of the package 400 and clock-gating various sub-systems in the package 400. In another embodiment, the ASIC 100 and/or processor 410 may monitor the system 600 to detect unsafe conditions like reverse polarity of the power supply or ESD discharge or overvoltage conditions and transmit a signal to the PMIC 640 to power gate the package 400 to prevent any damage to the package 400.

The signals from the automotive diagnostic port connector 650 may not be routed directly to the package 400 or PMIC 640. Instead, the signals may be conditioned or passed through one or more circuit components 620. In one embodiment, the circuit components 620 include a low-pass filter to smooth out the power supply from the vehicle. Vehicles can experience large voltage fluctuations due to the various components of the electrical system. For example, a starter motor, when the engine is being cranked, can draw a large amount of current, thereby dropping the voltage of the battery below 12 VDC. In addition, the alternator and distributor can generate a lot of noise in the vehicle's power supply. Consequently, the circuit components 620 may include capacitors and resistors sized to store energy and smooth out the power supply when experiencing short term voltage drops or spikes. In another embodiment, the circuit components 620 include current-limiting resistors placed in series between the pins of the connector 650 and the pads of the I/O port 110 of the ASIC 100. In one embodiment, each signal tied to an AGPIO of the I/O port 110 should include a 10 Ohm resistor in series with the pin on the connector 650 to limit the current drawn through the AGPIO circuit.

It will be appreciated that the system 600 is only one exemplary embodiment of an application for the ASIC 100. In other embodiments, the system 600 may include other components in addition to, or in lieu of, the components shown in FIG. 6. Such systems may take the form of, e.g., a laptop with a built-in automotive diagnostic connector to interface with a vehicle, a scan-tool used for diagnostic purposes, a data logger used to monitor the vehicle's electrical system and store diagnostic information in a solid-state drive, and many others.

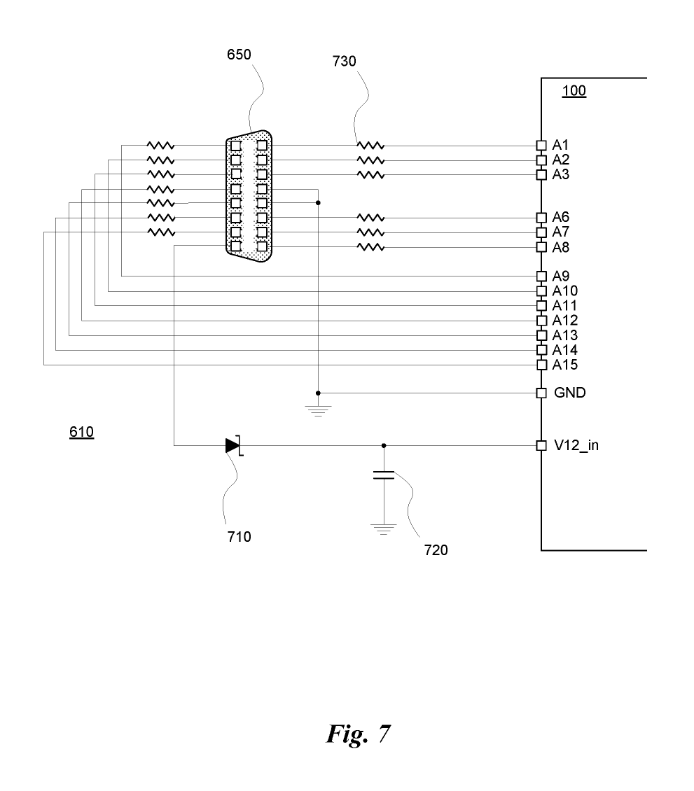

FIG. 7 illustrates a schematic for connecting the ASIC 100 to an automatic diagnostic port connector 650, in accordance with one embodiment. As shown in FIG. 7, the connector 650 is an OBD-II connector with 16 pins. Pins 4 and 5 are connected to a ground plane of the PCB 610. The ASIC 100 may also be coupled to the ground plane of the PCB 610. Pin 16 is connected to a V12_in pad of the ASIC 100, which supplies the ASIC 100 with a supply voltage. The 12 VDC power from the vehicle is connected, in series, with a Zener diode 710 before being connected to the V12_in pad of the ASIC 100. The V12_in pad is also connected to a capacitor 720. The other pins on the connector may be coupled to a pad 205 of an AGPIO (e.g., [A1-A3, A6-A15]), with a 10 Ohm, current-limiting resistor 730 between the pin and the pad 205.

It is noted that the techniques described herein, in an aspect, are embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media are included which may store data that is accessible by a computer, such as magnetic cassettes, flash memory cards, digital video disks, Bernoulli cartridges, random access memory (RAM), read-only memory (ROM), and the like.

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that various acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein include the one or more modes known to the inventor for carrying out the claimed subject matter. It is to be appreciated that variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. An application-specific integrated circuit (ASIC) configured to interface with an automotive diagnostic port, comprising:
a plurality of automotive general purpose input/outputs (AGPIOs), each AGPIO in the plurality of AGPIOs coupled to a pad configured to be connected to a corresponding signal of a plurality of signals included in the automotive diagnostic port; and
a digital toolbox that includes:
a number of modules configured to perform digital signal processing; and
a switch matrix coupled to the number of modules.

2. The integrated circuit of claim 1, wherein the switch matrix is programmable to connect an input and zero or more outputs of a particular module in the number of modules to at least one of an AGPIO and another module in the number of modules.

3. The integrated circuit of claim 1, wherein the switch matrix receives samples of the signals generated by at least one AGPIO in the plurality of AGPIO as inputs, and is configurable to cause zero or more AGPIO in the plurality of AGPIO to drive the corresponding signal according to an output of a module.

4. The integrated circuit of claim 3, wherein the samples of the signals may be specified as a source for one or more modules of the number of modules.

5. The integrated circuit of claim 1, wherein each AGPIO in the plurality of AGPIO includes at least one of a pull-up, pull-down sub circuit, an output driver sub-circuit, and an input path sub-circuit.

6. The integrated circuit of claim 1, further comprising a plurality of general purpose input/outputs (GPIO) operating at a 3.3 volts direct current (VDC) logic level.

7. The integrated circuit of claim 1, further comprising an analog multiplexor configured to select a pair of signals passed through a pair of AGPIO to a pair of pads included in an external Controller Area Network (CAN) bus port.

8. The integrated circuit of claim 1, further comprising a number of power generation components configured to regulate a vehicle supply voltage connected to the ASIC from the automotive diagnostic port.

9. The integrated circuit of claim 1, further comprising a real-time counter configured to trigger an interrupt at a periodic frequency based on a signal from an external crystal oscillator.

10. The integrated circuit of claim 1, further comprising a digital domain including a processor bus that is connected to a CPU core, wherein the digital toolbox is one component of the digital domain.

11. A system configured to interface with an automotive diagnostic port, comprising:
an application specific integrated circuit (ASIC) that includes:
a plurality of automotive general purpose input/outputs (AGPIOs), each AGPIO in the plurality of AGPIOs coupled to a pad configured to be connected to a corresponding signal of a plurality of signals included in the automotive diagnostic port, and
a digital toolbox that includes:
a number of modules configured to perform digital signal processing, and
a switch matrix coupled to the number of modules.

12. The system of claim 11, the system further comprising a processor coupled to the ASIC.

13. The system of claim 12, wherein the processor comprises a CPU core on a second integrated circuit die.

14. The system of claim 12, wherein the processor comprises a system-on-chip (SoC) that includes at least one of: one or more CPU cores, one or more GPU cores, and a memory management unit (MMU).

15. The system of claim 11, wherein the switch matrix is programmable to connect an input and zero or more outputs of a particular module in the number of modules to at least one of an AGPIO and another module in the number of modules.

16. The system of claim 11, wherein the switch matrix receives samples of the signals generated by at least one AGPIO in the plurality of AGPIO as inputs, and is configurable to cause zero or more AGPIO in the plurality of AGPIO to drive the corresponding signal according to an output of a module

17. The system of claim 11, wherein each AGPIO in the plurality of AGPIO includes at least one of a pull-up, pull-down sub circuit, an output driver sub-circuit, and an input path sub-circuit

18. The system of claim 11, wherein the ASIC further includes a number of power generation components configured to regulate a vehicle supply voltage connected to the ASIC from the automotive diagnostic port

19. The system of claim 11, wherein the ASIC further includes a real-time counter configured to trigger an interrupt at a periodic frequency based on a signal from an external crystal oscillator

20. The system of claim 11, wherein the ASIC further includes a digital domain including a processor bus that is connected to a CPU core, wherein the digital toolbox is one component of the digital domain.
